(19) United States
(12) Patent Application Publication
(10) Pub. No.: US 2026/0027707 A1
(43) Pub. Date: Jan. 29, 2026

(54) ROBOT CONTROL DEVICE, ROBOT SYSTEM, AND ROBOT CONTROL PROGRAM

(71) Applicant: Fanuc Corporation, Minamitsuru-gun, Yamanashi (JP)

(72) Inventor: Wanfeng FU, Minamitsuru-gun, Yamanashi (JP)

(73) Assignee: Fanuc Corporation, Minamitsuru-gun, Yamanashi (JP)

(21) Appl. No.: 18/996,139

(22) PCT Filed: Jan. 17, 2023
(86) PCT No.: PCT/JP2023/001171

§ 371 Date: Jan. 17, 2025

(51) Int. Cl. B25J 9/16; B25J 11/00; B25J 13/08

(52) U.S. Cl. CPC B25J 9/1633; B25J 9/1653; B25J 9/1674; B25J 9/1697; B25J 11/005; B25J 13/085

(57) ABSTRACT

Provided is a robot control device with which it is possible to efficiently and highly accurately perform fastening work using a fastener. The robot control device controls a robot and causes the robot to perform fastening work using a fastener, and is provided with a storage unit, an acquisition unit, a setting unit, and a control unit. The storage unit stores, in association with each other, information about fasteners and a parameter with regards to carrying out fastening work. The acquisition unit acquires, on the basis of output of a fastener recognition sensor, information about a fastener with which fastening work is to be performed. A setting unit acquires, on the basis of the acquired information about the fastener, the parameter associated with the information about the fastener from the storage unit, and sets the parameter. The control unit controls the robot on the basis of the set parameter.

### CROSS REFERENCE TO RELATED APPLICATIONS

This is the U.S. National Phase application of PCT/JP2023/001171, filed Jan. 17, 2023, the disclosure of this application being incorporated herein by reference in its entirety for all purposes.

### FIELD OF THE INVENTION

The present disclosure relates to a robot controller, a robot system, and a robot control program.

### BACKGROUND OF THE INVENTION

In recent years, a screw fastening robot system (robot system) that causes a robot to perform a fastening work by a fastener such as a screw, a bolt, and a nut has been used in various industries. As a screw fastening robot applied to such a screw fastening robot system, for example, a robot in which a nut runner (screw fastening device) and the like is attached to an arm tip part (hand) of a multi-joint robot, or a robot provided with a force sensor (Force Sensor) without using a nut runner to rotate and fasten the screw has been known.

For example, the screw fastening robot performs a screw fastening work (fastening work) to a workpiece (or a work target) flowing on a production line during a production operation. It should be noted, for example, when a plurality of types of bolts are screwed, a worker (operator, user) manually or automatically adjusts screw fastening parameters, and the robot is replaced with an appropriate socket, and then the robot performs the screw fastening work. In this case, it is required to appropriately set parameters that define the relationship between the force applied to the workpiece and the behavior of the robot when performing the screw fastening work (fastening work) by force-controlling the robot.

Conventionally, various proposals have been made as a robot system that causes a robot to perform a screw fastening work.

### Patent Literature

[PTL 1] Japanese Unexamined Patent Publication (Kokai) No. H02(1990)-237784
[PTL 2] International Unexamined Patent Publication No. 2020-518468

### SUMMARY OF THE INVENTION

As described above, in a robot system that causes a robot to perform a screw fastening work, for example, it has been necessary to perform the screw fastening work on a plurality of types of bolts, such as re-adjustment of parameters and processing such as replacement of a socket. Therefore, there is a problem that time and effort are required for processing, and in particular, non-efficiency is caused in the production line.

Further, when performing the screw fastening work on a plurality of types of bolts, it is difficult to control the magnitude and direction of force applied to each bolt, and it is difficult to highly accurately perform the screw fastening work of a bolt, for example.

Therefore, it is desired to provide a robot controller, a robot system, and a robot control program with which it is possible to efficiently and high accurately perform a fastening work by a fastener.

According to an embodiment of the present disclosure, there is provided a robot controller for controlling a robot and causing the robot to perform a fastening work using a fastener, including a storage unit, an acquisition unit, a setting unit, and a control unit.

The storage unit is configured to store information of the fastener and parameters of performing the fastening work in association with the information of the fastener, and the acquisition unit is configured to acquire information of the fastener performing the fastening work based on an output of a fastener recognition sensor. The setting unit is configured to acquire and set the parameters associated with the information of the fastener from the storage unit based on the acquired information of the fastener, and the control unit is configured to control the robot based on the set parameters.

The objects and effects of the present invention will be recognized and obtained by using the components and combinations pointed out in the claims. Both the general description described above and the detailed description below are exemplary and descriptive and do not limit the invention described in the claims.

### BRIEF DESCRIPTION OF DRAWINGS

FIG. 1 is a diagram schematically depicting an example of a robot in a robot system according to the present embodiment.

FIG. 2 is a block diagram depicting an example of the robot system according to the present embodiment.

FIG. 3 is a diagram for explaining an example of a vision tracking of the example of the robot system according to the present embodiment.

FIG. 4 is a diagram for explaining processing associated with a fastening work in the vision tracking depicted in FIG. 3.

FIG. 5 is a diagram for explaining an example of an image by a visual sensor in the example of the robot system according to the present embodiment.

FIG. 6 is a diagram for explaining an example of processing by a force sensor in the example of the robot system according to the present embodiment.

FIG. 7 is a diagram for explaining an example of an image displayed on a display device of the example of the robot system according to the present embodiment.

FIG. 8 is a block diagram depicting another example of the robot system according to the present embodiment.

FIG. 9 is a diagram for explaining an example of processing in an example of a robot control program according to the present embodiment.

FIG. 10 is a flowchart for explaining an example of processing in the example of the robot control program according to the present embodiment.

FIG. 11 is a flowchart for explaining an example of processing in another example of the robot control program according to the present embodiment.

### DETAILED DESCRIPTION OF EMBODIMENTS OF THE INVENTION

Hereinafter, examples of a robot controller, a robot system, and a robot control program according to the present embodiment will be described in detail with reference to the accompanying drawings. In each of the drawings, the same or similar constituent elements are assigned the same or similar reference signs. Furthermore, the embodiments described below do not limit the technical scope and meaning of the terms of the invention set forth in the claims.

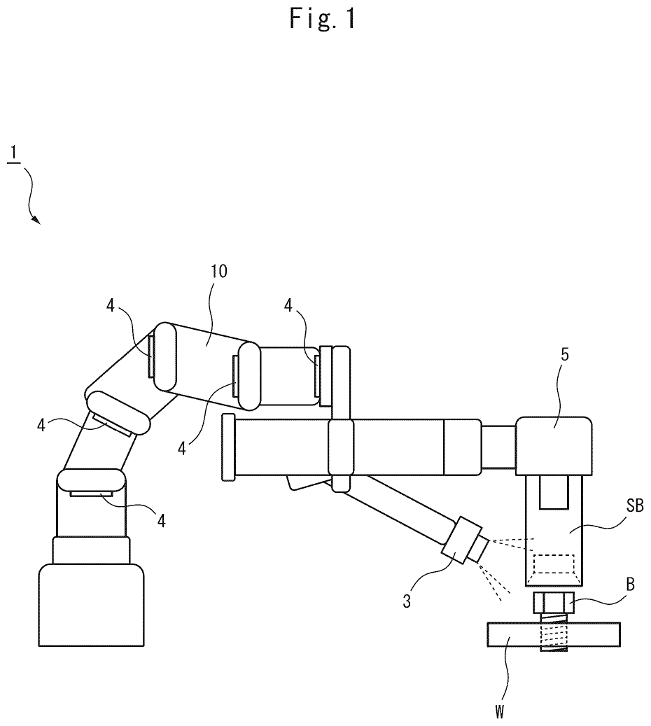

FIG. 1 is a diagram schematically depicting an example of a robot in a robot system according to the present embodiment. In FIG. 1, a reference sign 1 denotes a robot (screw fastening robot), 3 denotes a visual sensor (fastener recognition sensor), 4 denotes a force sensor (Force Sensor), 5 denotes a nut runner (screw fastening device), SB denotes a socket (impact socket), B denotes a bolt, and W denotes a workpiece (work target).

As depicted in FIG. 1, the robot 1 is constituted by a multi-joint robot, and a nut runner 5 is attached to a tip (hand) of an arm 10. In this case, each joint portion (shaft) of the robot 1 is provided with a force sensor 4. The force sensor 4 detects a magnitude and direction (moment) of the force at each joint portion of the robot 1, and is configured as, for example, a torque sensor (built-in torque sensor) built in each joint portion.

In other words, FIG. 1 depicts an example in which the force sensor 4 is configured as a built-in torque sensor provided in each joint. The force sensor 4 is not limited to the built-in torque sensor provided in each joint portion, but may be configured as, for example, a force sensor provided on a base of the robot 1. Further, for example, the force sensor 4 may detect a force of a rotation axis of the nut runner 5 (shaft for fastening the screw), that is, a magnitude and direction of the force applied to the bolt B.

It should be noted that a visual sensor 3 for capturing an image of a workpiece W and the bolt B is, for example, attached to a tip of the arm 10. The visual sensor 3 includes, for example, an imaging element such as a charge coupled device (CCD) or a complementary metal oxide semiconductor (CMOS), an optical lens for focusing the image on the imaging element, an image processing processor and the like, and acquires visual information.

In this case, the visual sensor 3 may be constituted by, a plurality of visual cameras for capturing a three-dimensional shape, a LiDAR (Light Detection And Ranging), a ToF (Time-of-Flight) camera, or a camera using a light cutting method by a laser light and the like. Further, depending on objects and specifications to which the robot system is applied, a two-dimensional sensor (one visual camera) that captures a two-dimensional shape may also be applied to reduce costs. In addition, the visual sensor 3 is not limited to mounting on the tip of the arm 10, but may be provided above or on the robot 1, and may be configured by combining a plurality of devices arranged at different positions.

It should be noted that the visual sensor 3 is an example of a fastener recognition sensor that recognizes information (information of the fastener B) such as a type of the bolt (fastener) B for performing a screw fastening work and a position to the workpiece W and the like, and is not limited to the visual sensor if the information (for example, the size information) of the fastener B may be acquired. Further, FIG. 1 depicts a case where the nut runner 5 fastens the bolt B to the workpiece W, but the bolt B may be a screw, a nut, or another fastening component (fastener). In addition, the nut runner 5 and the socket SB are merely examples, and various external devices capable of fastening the fastener may also be applied.

The nut runner 5 is replaced by, for example, a socket (impact socket) SB suitable for the type of the bolt B fastened to the workpiece W based on an output of the visual sensor 3 (command of the robot controller 2), and fastens the bolt B to a predetermined portion of the workpiece W by the socket SB. Further, the nut runner 5 controls, for example, a magnitude of a force for fastening the bolt B (fastening torque and the like: parameters) to the predetermined portion of the workpiece W based on an output of the force sensor 4 (command of the robot controller 2). In this case, a tip of the bolt B has already inserted into the predetermined portion (fastening hole) of the workpiece W, but it is not possible to change and deform various depending on the nut runner 5 and a screw fastening mechanism of the robot 1.

In the above, although FIG. 1 depicts a state in which the bolt B is fastened downward from above in a vertical direction with respect to the workpiece W, a fastening direction of the bolt B with respect to the workpiece W may be possible to any direction. In addition, the robot 1 is not limited to a multi-joint robot, and further is not limited to perform the screw fastening work by the nut runner 5. In other words, other various external devices capable of screw fastening may be applied without using the nut runner 5, or may be a robot having an additional shaft (fastening motor: electric motor) for fastening the bolt B. When the robot 1 includes an additional shaft for fastening the bolt B without using the nut runner 5, the force sensor 4 may be provided at an arbitrary position if a magnitude and direction of the force for fastening the bolt B may be detected by the additional shaft. Further, the robot 1 is not limited to fastening of a bolt and a screw, and may perform fastening works of various fasteners. For example, in the case of the work of inserting a pin (fastener) into a hole instead of the work of screwing the bolt B into the hole, for example, an operation of selecting and inserting (fastening) an optimum pin into a hole based on information (size information) of a size of the hole captured by the visual sensor 3 may be performed.

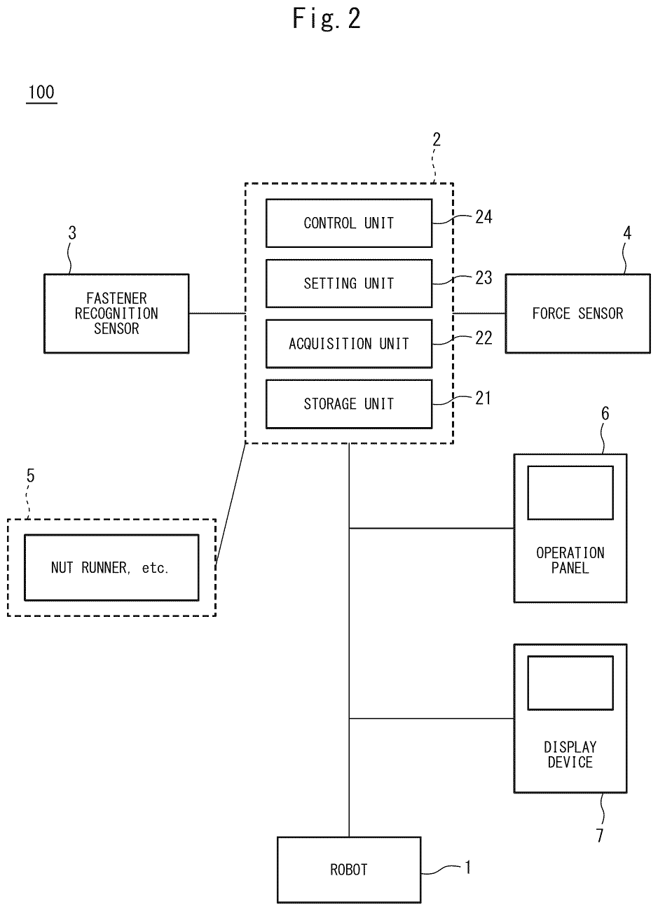

FIG. 2 is a block diagram depicting an example of the robot system according to the present embodiment. As depicted in FIG. 2, the robot system 100 according to the present embodiment includes a robot (screw fastening robot) 1, a robot controller 2, a fastener recognition sensor 3, a force sensor 4, a nut runner 5, an operation panel (teaching operation panel) 6, and a display device 7. It should be noted that the visual sensor is an example of a fastener recognition sensor 3 that recognizes information (information on a fastener) such as a type of a bolt B that performs a fastening work (screw fastening work) and a position to the workpiece W, and the fastener recognition sensor 3 is not limited to the visual sensor.

The robot controller 2 controls the robot 1 to perform the fastening work (screw fastening work) using the fastener (bolt B), and includes a storage unit 21, an acquisition unit 22, a setting unit 23, and a control unit (arithmetic processing device) 24. An output of the fastener recognition sensor 3 and an output of the force sensor 4 input to the robot controller 2, and the robot controller 2 causes the robot 1 to perform the fastening work based on information of the fastener, which will be described in detail below.

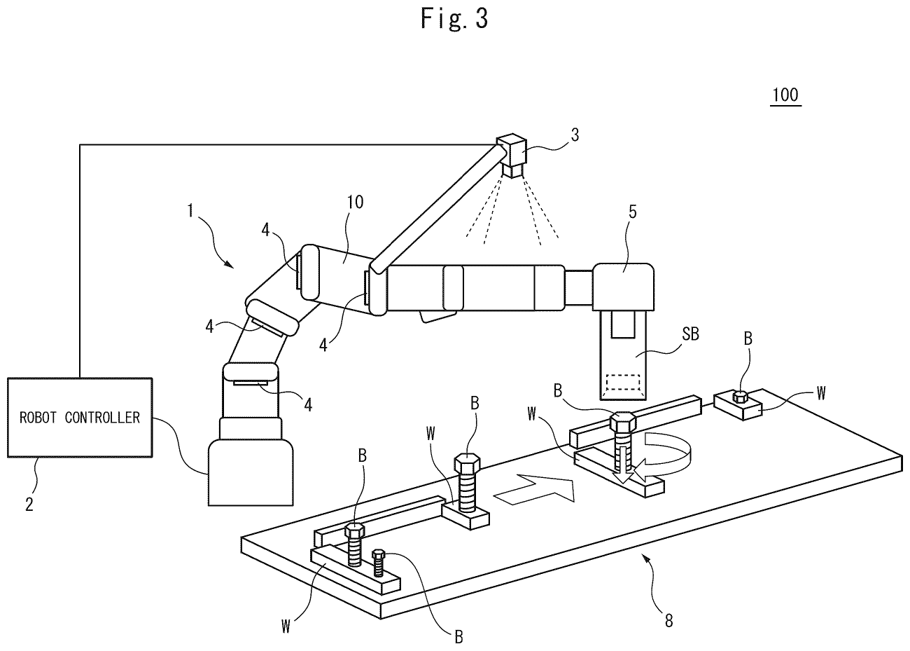

The storage unit 21 stores a robot control program for controlling the robot 1 by the control unit 24 to perform the fastening work using the fastener. In addition, the storage unit 21 stores model information of the fastener (detection models VB1, VB2, . . . of a plurality of different types of bolts B1, B2, . . . ) and parameters (parameters FB1, FB2, . . . of a force control) when performing the fastening work in association with each other (corresponding to each other). Further, the storage unit 21 stores the model information of the fastener and information (SB1, SB2, . . . ) of the sockets used for the fastening work in association with each other. It should be noted that a processing in an example of a vision tracking to which an example of the robot system according to the present embodiment is applied will be described in detail with reference to FIG. 3 to FIG. 6.

The acquisition unit 22 acquires information of the fastener that performs a fastening work based on the output of the fastener recognition sensor 3. In other words, the acquisition unit 22 receives imaging information captured by the visual sensor 3, for example, and acquires model information (detection model VB) of the bolt B that performs screw fastening work, position information for the workpiece W and the like. In this case, the information of the fastener includes, for example, not only the bolt information indicating the type of the bolt B that performs the screw fastening work, but also the position information and the like for the workpiece W of the bolt B that performs the screw fastening work. This is because even when the same bolt B is screwed, appropriate parameters such as a fastening torque are different depending on the position of the workpiece W.

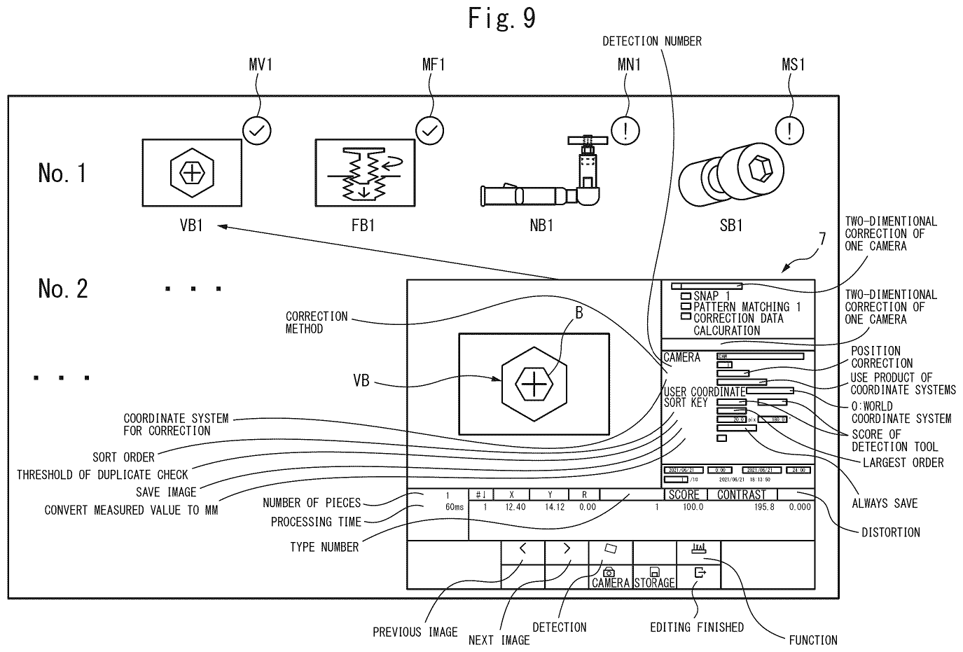

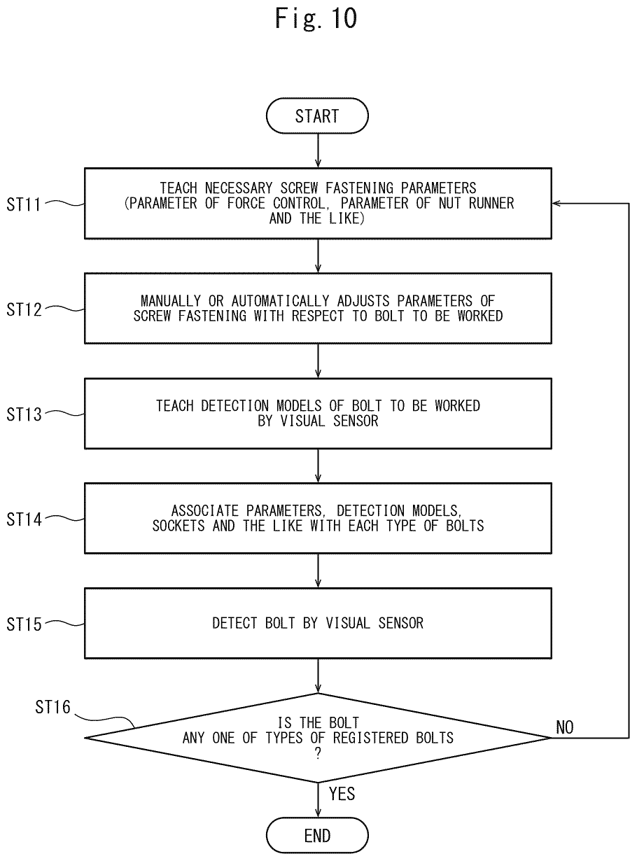

The setting unit 23 acquires and sets parameters corresponding to a fastener from the storage unit 21 based on the acquired information of the fastener. In other words, the setting unit 23 acquires and sets parameters associated with the acquired information (for example, the size information) of the bolt B from the storage unit 21 based on the model information and the like of the bolt B acquired by the acquisition unit 22. In this case, the parameters stored in the storage unit 21 based on the model information and the like of the bolt B may be set to, for example, for the model information of the bolt B assumed in advance before the screw fastening work is actually performed. It should be noted that the example of the processing performed in advance will be described in detail later with reference to FIG. 9 and FIG. 10.

The control unit 24 controls the robot 1 based on the set parameters and causes the robot 1 to perform a fastening work of the fastener. In other words, for example, the control unit 24 controls the robot 1 to perform a screw fastening work by using the parameters set based on the model information of the bolt B and the position information on the workpiece W. In this case, the control unit 24 may automatically select (automatically change) the socket SB for fastening the bolt B to a socket corresponding to the type of the bolt B that performs the screw fastening work (automatically replacing the socket), and the screw fastening work may be performed by the robot 1. It should be noted that the automatic selecting of the sockets may be applied with various known methods.

As described above, the fastener recognition sensor 3 is used to recognize information such as a type of the fastener B that performs the screw fastening work and its position relative to the workpiece W, and it may be applied with a visual sensor 3 for capturing an image including the fastener B and the workpiece W. It should be noted that the visual sensor 3 may be constituted by a LiDAR, a ToF camera, or a camera using a laser light optical cutting method, as described above.

The force sensor 4 is, for example, a sensor for detecting and feedback-controlling parameters of a force control such as a pressing force or a fastening moment applied to the fastener by the nut runner 5. As the force sensor 4, a multi-axial force sensor including a plurality of strain gauges provided in each joint portion of the robot 1, a built-in torque sensor, and a force sensor for detecting a force applied to an additional shaft for fastening the screw may be applied.

The operation panel 6 is, for example, used to allow a worker to move with his/her hand and to teach various operations to the robot 1, and the display device 7 is used to notify the worker of various information by an image. The display device 7 may also be installed on the operation panel 6 or the robot controller 2 without being disposed as a separate device. In addition, the operation panel 6 and the display device 7 may be selected and applied appropriately depending on a target to which the robot system 100 is applied, the work to be performed by the robot 1, and the like.

FIG. 3 is a diagram for explaining an example of a vision tracking of the example of the robot system according to the present embodiment. In this case, the vision tracking is also referred to as a conveyor tracking, and it performs a predetermined work on a workpiece (work target) W onto a conveyor provided with a sensor that recognizes the moving distance and speed using an output of the visual sensor (vision camera). In other words, FIG. 3 depicts how multiple types of bolts B are screwed onto multiple workpieces W in a production line using the conveyor.

In FIG. 3, a reference sign 1 denotes is a robot, 2 denotes a robot controller, 3 denotes a vision sensor, 4 denotes a force sensor, 5 denotes a nut runner, 8 denotes a conveyor, B denotes a bolt, and W denotes a workpiece. As depicted in FIG. 3, the conveyor 8 is moved from a lower left to an upper right in the drawing, and the robot 1 is controlled by the robot controller 2 for the plurality of workpieces W onto the moving conveyor 8 to perform a screw fastening work of the bolt B. In this case, the bolt B is previously inserted into the fastening hole of the workpiece W at a tip of the bolt B, the socket SB corresponding to the model (type) of each bolt B is replaced, and the bolt B is fastened (screwed) to the predetermined portion of the workpiece W.

In other words, the robot controller 2 acquires, based on the image information captured by the visual sensor 3, information (detection model) VB of the bolt B that performs the screw fastening work, and position information and the like for the workpiece W of the bolt B. Further, the robot controller 2 sets corresponding parameters based on the acquired model information of the bolt B and the position information for the workpiece W and causes the robot 1 (nut runner 5) to perform the screwing work of the bolt B by the set parameters.

At this time, if the model of the bolt B that performs a next screw fastening operation is different from the model of bolt B that performed a screw fastening operation immediately before, the socket SB is replaced with a bolt B one that corresponds to the bolt B that performs the next screw fastening operation, and then the screw fastening work is performed. When performing the screw fastening work of the bolt B, the robot controller 2 controls parameters for actually performing the screw fastening work based on the parameters corresponding to the set bolt B and an output of the force sensor 4.

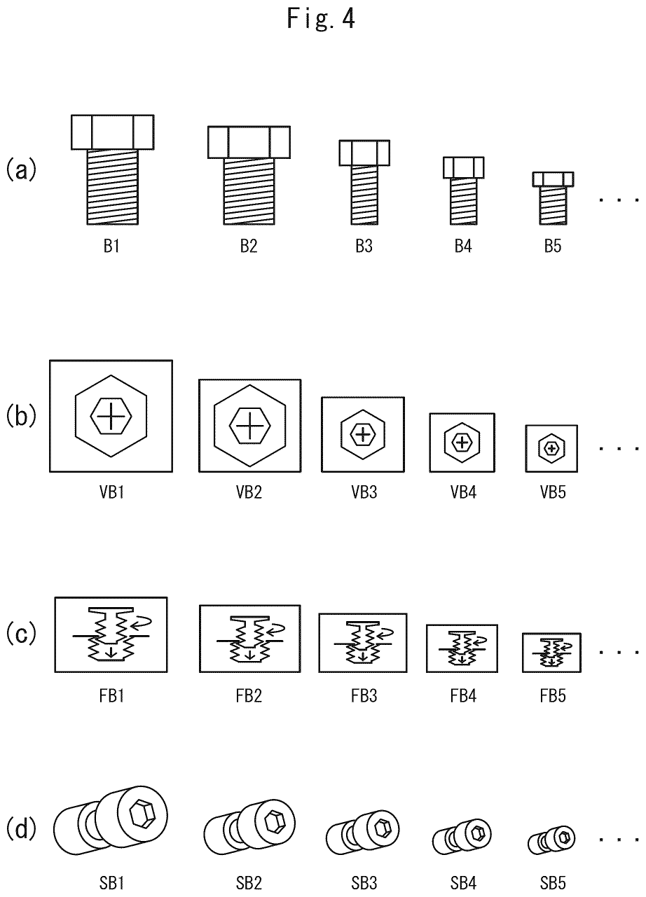

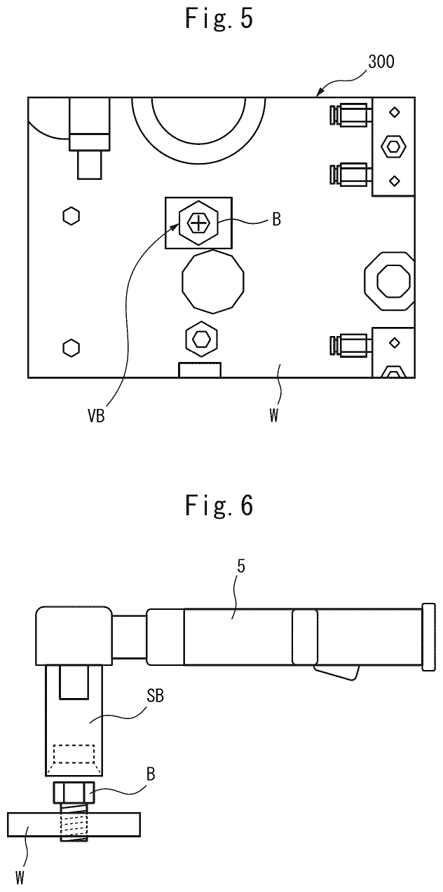

FIG. 4 is a diagram for explaining processing associated with a fastening work in the vision tracking depicted in FIG. 3. Further, FIG. 5 is a diagram for explaining an example of an image by a visual sensor in an example of the robot system according to the present embodiment. In addition, FIG. 6 is a diagram for explaining an example of processing by the force sensor according to an embodiment of the robot system according to the present embodiment and depicts a part of the nut runner 5 attached to the tip of the arm 10 in the robot 1.

In this case, FIG. 4(a) depicts different types B1, B2, B3, . . . of fasteners (bolts B), and FIG. 4(b) depicts detection models VB (VB1, VB2, VB3, . . . ) corresponding to the bolts B (B1, B2, B3, . . . ). Further, FIG. 4(c) depicts parameters FB (FB1, FB2, FB3, . . . ) corresponding to the bolts B (B1, B2, B3, . . . ), and FIG. 4(d) depicts sockets SB (SB1, SB2, SB3, . . . ) corresponding to the bolts B (B1, B2, B3, . . . ).

It should be noted that in FIG. 4(c), only a force (axial force) in an axial direction and a force (fastening torque) in a rotational direction for pressing the bolt B are depicted as the parameter FB, but they are not only possible to include other various parameters. Although the parameter FB is one type for different types of bolts B, but for example, a plurality of different parameters adjusted according to the type, position and the like of the workpiece W to be screwed to the same bolt B may be made to correspond to each other. This is because, for example, even for the bolt B of the same model, parameters such as optimum fastening torque differ depending on the fastening position with respect to the workpiece W.

First, as explained with reference to FIG. 1 and FIG. 2, the plurality of different types of bolts B1, B2, B3, . . . , and the parameters FB1, FB2, FB3, . . . when fastening the bolts B1, B2, B3, . . . are associated with each other and stored in the storage unit 21. Further, the storage unit 21 may store the types of bolts (model information) B1, B2, B3, . . . and the types of sockets SB (socket information) SB1, SB2, . . . in association with each other. It should be noted that the association (teaching processing) of the parameters FB1, FB2, FB3, . . . with respect to the plurality of bolts B1, B2, B3, . . . of different types will be described in detail later with reference to FIG. 9 and FIG. 10.

As depicted in FIG. 5, for example, the acquisition unit 22, for example, extracts and acquires information of the bolt B (detection model VB) from an image (captured image) 300 captured by the visual sensor 3. Further, the acquisition unit 22 compares the detection model VB extracted from the captured image 300 by the visual sensor 3 with the detection models VB1, VB2, VB3, . . . depicted in FIG. 4(b), and identifies (recognizes) the model of the bolt B that performs the screw fastening work.

As depicted in FIG. 5, the captured image 300 by the visual sensor 3 includes not only a bolt B for performing a screw fastening work but also various components attached to the workpiece W. Therefore, the acquisition unit 22 extracts the bolt B for performing the screw fastening work from the captured image 300 including the various components and the like, and acquires the information (detection model) VB of the bolt B.

The setting unit 23 reads out parameters corresponding to the detection model VB of the acquired bolt B from the storage unit 21 and sets the parameters. In this case, the parameters set by the setting unit 23 include, for example, a parameter FB of a force control and a parameter (NB) of a nut runner 5. It should be noted that, if it is possible to acquire the position information for the workpiece W of the bolt B to which the acquisition unit 22 performs the screw fastening work, the setting unit 23 may set the parameter FB (NB) corresponding to detection model VB of the bolt B in which not only the model information of the bolt B but also the position information for the workpiece W is added.

For example, as depicted in FIG. 6, the control unit 24 moves a tip of the socket SB of the nut runner 5 attached to the tip of the arm 10 of the robot 1 to the position of the bottle B that performs a screw fastening work based on the captured image 300 by the visual sensor 3. Further, the control unit 24 causes, for example, a head of the bottle B for performing the screw fastening work to be fitted into the tip of the socket SB of the nut runner 5, and controls the robot 1 (nut runner 5) based on the set parameter FB (NB) to perform the screw fastening work of the bolt B.

In other words, the control unit 24 controls the robot 1 to perform a screw fastening work with the parameter FB set by the setting unit 23 based on the model information of the bolt B and the position information and the like with respect to the workpiece W. In this case, the control unit 24 automatically selects the socket SB for fastening the bolt B to the socket SB corresponding to the type of the bolt B performing the screw fastening work and may perform the screw fastening work on the robot 1 as described above.

It should be noted that the visual sensor 3 may be constituted by a LiDAR, a ToF camera, or an optical device to which a light cutting method by laser light is applied, without being limited to a visual camera, if a type and the like of the bolt B that performs a screw fastening work may be identified. Further, a position of the bolt B that performs the screw fastening work on the workpiece W is not limited to being calculated from an image captured by the visual sensor 3, but may be calculated, for example, by a tip position of the socket SB of the nut runner 5 obtained from a rotation angle and the like of each shaft of the robot 1.

Alternatively, although depending on an application target, for example, the detection model VB of the bolt B may also be recognized with repeating the process of replacing the socket SB and fitting the bolt B by using the tip of the socket SB as the fastener recognition sensor 3.

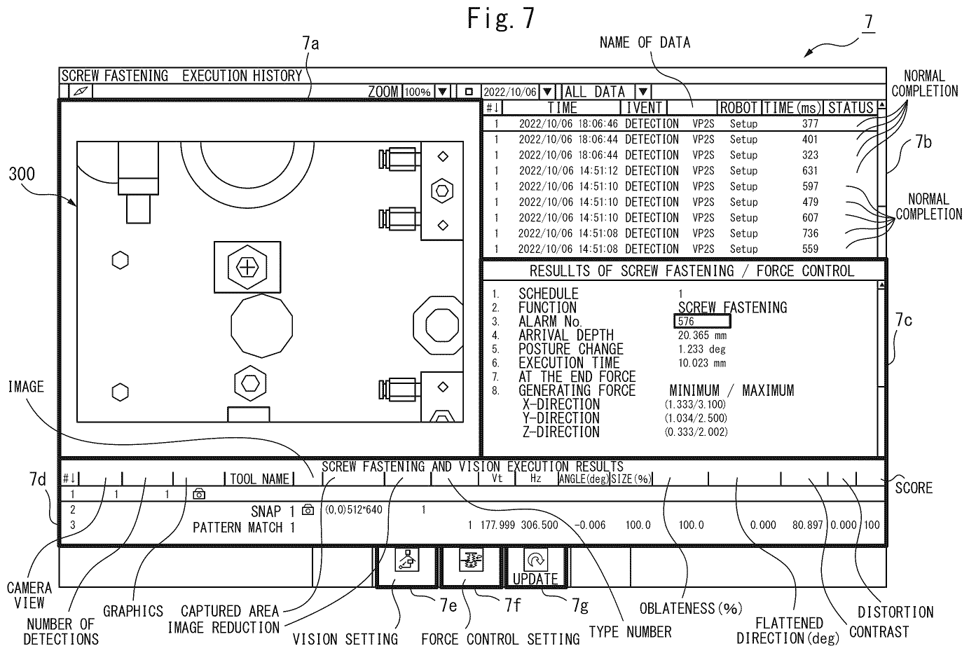

FIG. 7 is a diagram for explaining an example of an image displayed on a display device of the example of the robot system according to the present embodiment and depicts an example of a display image when an abnormality occurs in the screw fastening work. As described with reference to FIG. 2, a display device 7 may be disposed as a single device, but may also be provided on an operation panel 6 that teaches various operations on the robot controller 2 or the robot 1.

Further, the display device 7 may be connected to the robot controller 2 via a communication line (for example, LAN (Local Area Network)) without being disposed in the vicinity of the robot 1 and may also be provided in a place (operation chamber and the like) separated from the robot 1. In this case, in the operation chamber and the like provided with the display device 7, for example, an operator (worker) may perform various processes with reference to the display device 7. In addition, the image displayed on the display device 7 is not limited to an image of a time point (real time) at which the screw fastening work is actually performed, and for example, it may be an image obtained by reproducing the screw fastening work using the stored data.

As depicted in FIG. 7, for example, display regions 7a to 7d for performing various processes with reference to the operator are disposed on the display device 7 (display screen). In this case, the display region 7a displays an image 300 captured by the visual sensor 3, for example, the image depicted in FIG. 5 described above as it is, and the display region 7b displays a work performed by the robot 1 (the robot system 100) based on a passage of time. In addition, the display region 7c displays an execution history of a force control of the screw fastening work (screw fastening and force execution results), and the display region 7d displays an execution history of a vision of the screw fastening work (screw fastening and vision execution results).

Further, for example, touch-type or pressing-type operation buttons (operation regions) 7e to 7g are also disposed on the display device 7. For example, the operation button 7e is used for transferring the display screen to a vision (visual) parameter setting screen for adjusting parameters of the vision when an abnormality occurs. In addition, for example, the operation button 7f is used for transferring the display screen to a force control (force) parameter setting screen for adjusting parameters of the force control when an abnormality occurs. Furthermore, for example, the operation button 7g is used for updating the setting. It should be noted that the adjustment of the visual/force control parameters (including the adjustment of the parameter NB such as a nut runner and the like) may be automatically performed, but may also be manually performed by considering various conditions such as articles and specifications to be an object by a worker.

It this case, for example, when a force control execution alarm occurs during the force control is performed, items of visual/force parameters related to that alarm may be automatically highlighted in the display region 7c, and the worker may specify and solve problems within a short time. It should be noted that the alarm (warning information) may be recognized by the worker, for example, by a warning display in the screen of the display device 7 or a warning output unit such as a warning sound by the robot controller 2 and the operation panel 6 or an output of a warning lamp and the like.

Specifically, for example, when a screw fastening work (2. function screw fastening) is performed, a torque is large, an insertion depth is short, and a case where an alarm occurs is considered. In other words, the screw fastening work is performed without inserting the bolt B at a correct angle with respect to a fastening hole, and a case where an alarm (3. alarm number 576) is generated by the force control is considered.

At this time, in the display region 7a, an image (captured image 300 by the visual sensor 3) where an alarm is generated while performing a screw fastening work of the bolt B may be displayed. Further, in the display region 7c, an angle (5. posture change deg) of information (detection model: vision model) VB of performing the screw fastening work of the bolt B, which is visually detected, may be displayed together with a torque (8. generating force large) applied to the bolt B and an insertion depth (4. arrival depth short) when an alarm occurs.

As a result, the worker may easily identify, for example, the cause of an alarm (abnormality occurrence) generated in the screw fastening work of the bolt B in a short time. Further, the worker may not only identify the cause of the alarm, but also may set the vision setting and the force control setting (visual and force parameters) not to cause the similar abnormality by using the display regions 7b and 7d and the operation buttons 7e to 7g. Specifically, in the screw fastening work by the force control, the worker may intuitively grasp the diagnosis data when the abnormality occurs, so that the cause of failure of the screw fastening work may be easily followed in a short time. It should be noted that the display screen (display device 7) depicted in FIG. 7 is merely an example, and it is of course that various modifications and variations may be possible.

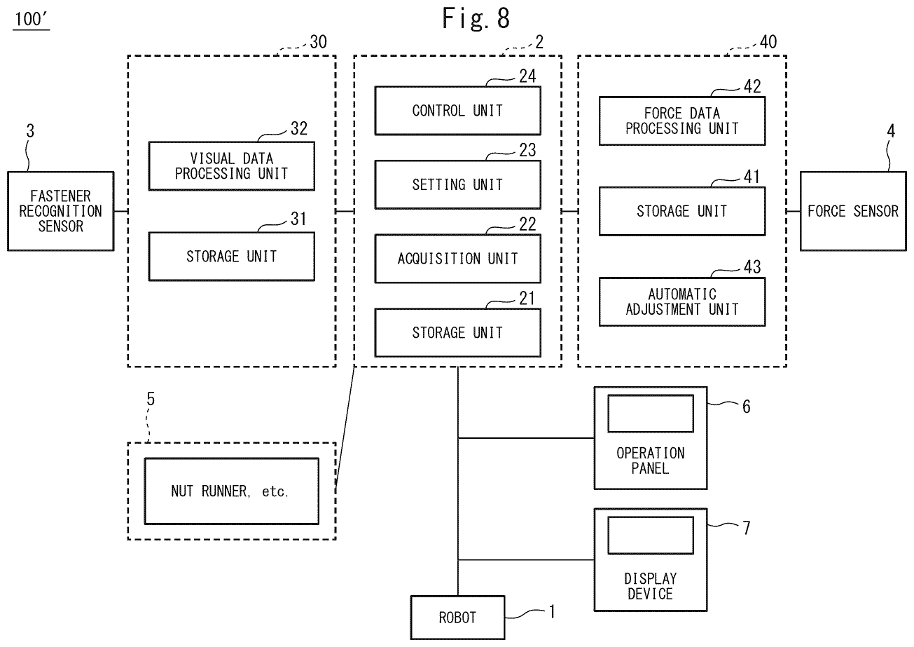

FIG. 8 is a block diagram depicting another example of the robot system according to the present embodiment. The robot system 100′ of the present embodiment includes a robot 1, a robot controller 2, a visual sensor 3, a visual data processing device 30, a force sensor 4, a force data processing device 40, a nut runner 5, an operation panel 6, and a display device 7.

In other words, as is clear from the comparison between FIG. 8 and FIG. 2, the robot system 100′ depicted in FIG. 8 is added with the visual data processing apparatus 30 and the force data processing apparatus 40. Specifically, in the robot system 100 depicted in FIG. 2, the visual data processing device 30 and the force data processing device 40, for example, divide and process various functions in the robot controller 2.

The visual data processing device 30 is provided between the visual sensor 3 and the robot controller 2, and includes a storage unit 31 and a visual data processing unit 32. The visual data processing unit 32 receives and processes an image captured by the visual sensor 3, and may include, for example, a part of functions of an acquisition unit 22 that extracts and acquires a detection model VB of the bolt B from the captured image. For example, the storage unit 31 may include a part of functions of a storage unit 21 that stores in advance the detection models VB1, VB2, VB3, . . . depicted in FIG. 4(b). It should be noted that, for example, the visual data processing unit 32 may include some functions of a control unit 24 that compares an extracted detection model VB with the detection models VB1, VB2, VB3, . . . depicted in FIG. 4(b) to identify a model of the bolt B that performs screw fastening work.

The force data processing device 40 is provided between the force sensor 4 and the robot controller 2, and includes a storage unit 41, a force data processing unit 42, and an automatic adjustment unit 43. The force data processing unit 42 receives an output of the force sensor 4 and determines a magnitude and direction of the force. It should be noted that, for example, the force data processing unit 42 may include a part of functions of the control unit 24 that performs a feedback control based on a pressing force or fastening torque applied to the bolt B obtained by processing the output of the force sensor 4.

The storage unit 41 includes, for example, a part of functions of the storage unit 21 that stores parameters FB1, FB2, FB3, . . . corresponding to each bolt depicted in FIG. 4(c). Further, the automatic adjustment unit 43 includes, for example, a part of functions of the control unit 24 that automatically adjusts (feedback control) a force applied to the bolt B by the robot 1 (nut runner 5) according to parameters corresponding to the bolt B that performs a screw fastening work.

In this case, the force data processing apparatus 40 may be used to prepare parameters for each of the bolts B1, B2, B3, . . . , for example, before actually performing the screw fastening work. It should be noted that, for example, the automatic adjustment unit 43 may apply a known technique for adjusting the parameters by automatically executing the force control a plurality of times. As described above, the robot system according to the present embodiment is not limited to those depicted in FIG. 2 and FIG. 8, and of course may be changed and deformed in various ways.

FIG. 9 is a diagram for explaining an example of processing in an example of a robot control program according to the present embodiment, and FIG. 10 is a flowchart for explaining an example of processing in the example of the robot control program according to the present embodiment. It should be noted that FIG. 9 and FIG. 10 are diagrams for explaining an example of processing of a pre-teaching program (bolt registration program) which is performed before a screw fastening process in an actual production line.

For example, the pre-teaching program is stored in the storage unit 21 of the robot controller 2, and the control unit 24 executes a setting of each item manually or automatically based on an image (detection model) VB of the bolt B extracted from the image captured by the visual sensor 3. Specifically, for example, when a part of a teaching processing is manually performed, by operating (pressing) a button VB1 of No. 1 in FIG. 9, a screen such as a lower right is displayed on a display device 7, and various items may be set.

In other words, respective detection models VB1, VB2, . . . (VB), force control parameters FB1, FB2, . . . (FB), nut runner parameters NB1, NB2, . . . (NB), and sockets SB1, SB2, . . . (SB) are stored (taught) in the storage unit 21. It should be noted that a completion/non-completion of the teaching processing in each item may be confirmed by a completion mark at an upper right portion of each item. Specifically, in FIG. 9, with respect to the detection model VB1 and the parameter FB1, the teaching process has been completed (MV1, MF1), and regarding the nut runner NB1 and the socket SB1, the teaching process is not completed (MN1, MS1).

In the above descriptions, FIG. 9 only depicts an example, and items to be set in association with the detection model VB of the bolt B extracted from the captured image by the visual sensor 3, and screens and operations displayed on the display device 7 may be variously modified and changed. Next, an example of processing in the example of the robot control program according to the present embodiment will be described with reference to the flowchart of FIG. 10.

As depicted in FIG. 10, when an example of processing in the example of the robot control program (pre-teaching program) according to the present embodiment starts (START), necessary screw fastening parameters are taught in step ST11. In other words, in step ST11, the parameters necessary for performing a screw fastening work such as a parameter FB of the force control and a parameter NB of a nut runner 5 are taught. It should be noted that, when applying an additional shaft for fastening a bolt B to a robot 1 without using the nut runner 5, the parameters (NB, FB) required to perform the screw fastening work with the external device or the additional shaft may be taught. The teaching of these parameters may be applied, for example, a well-known technique for automatically adjusting parameters by automatically executing the force control of a plurality of times. It is also possible to manually set or adjust the parameters.

Next, the process proceeds to step ST12, and wherein the parameters of the screw fastening are manually or automatically adjusted with respect to the bolt B to be worked. For example, although the values prepared in advance by the manufacturer (provider) may be automatically adjusted (set) with respect to the plurality of bolts (B1, B2, B3, . . . ) to be worked, the operator (worker) itself may individually adjust (finely adjust). The automatic adjustment of the parameters (FB, NB) may be performed by, for example, the automatic adjustment unit 43 (force data processing device 40) in FIG. 8 described above.

Further, the process proceeds to step ST13, and wherein the detection models VB1, VB2, VB3, . . . of the bolt to be worked are taught by the visual sensor 3. In other words, in step ST13, an image (VB1, VB2, VB3, . . . ) of each bolt in the image captured by the visual sensor 3 is taught.

In addition, the process proceeds to step ST14, and wherein the parameters, the detection models, the sockets and the like are associated with each type of the bolts. For example, as described with reference to FIG. 4, the parameters FB1, FB2, . . . , the sockets SB1, SB2, . . . and the like of the detection models VB1, VB2, . . . are associated with each type B1, B2, . . . of the bolts.

Further, the process proceeds to step ST15 and wherein a bolt B is detected by the visual sensor 3, and the process proceeds to step ST16. In step ST16, it is determined whether or not the detected bolt B is any one of types of registered bolts, wherein when it is determined that the detected bolt B is not any of the types of the registered bolts (NO), the process returns to step ST11 and the same processing may be performed, and when it is determined that the detected bolt B is one of the types of the registered bolts (YES), the process is ended (END). It should be noted that the pre-teaching program described above is merely an example, and of course it may be changed and modified in various ways.

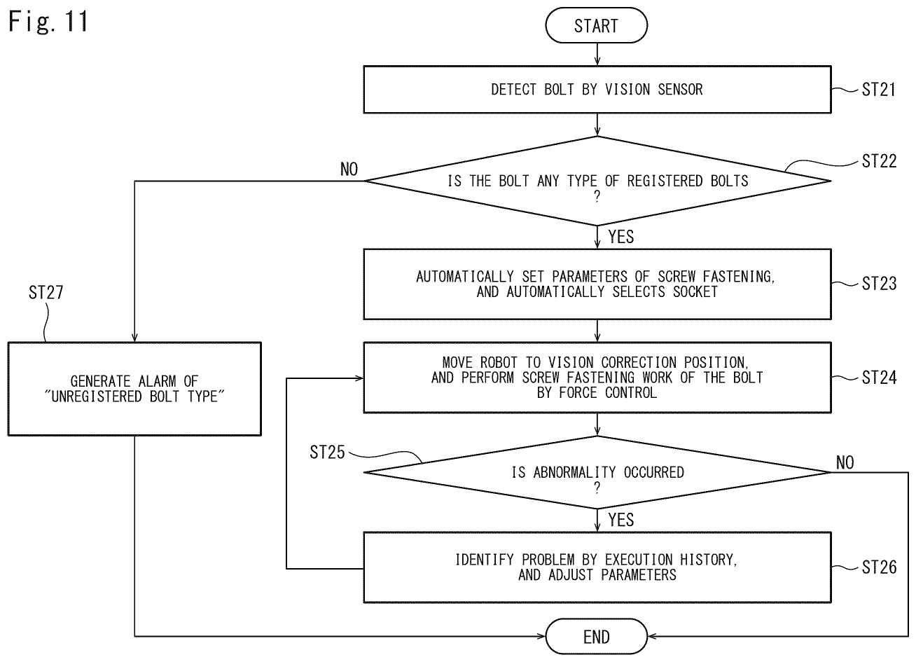

FIG. 11 is a flowchart for explaining an example of processing in another example of the robot control program according to the present embodiment, and an example of a screw fastening process of a bolt to the workpiece W is described in an actual production line. Other examples of the robot control program according to the present embodiment may be stored in the storage unit 21 of the robot controller 2 depicted in FIG. 2 and executed by the control unit (arithmetic processing device) 24.

As depicted in FIG. 11, when an example of processing in another example of the robot control program (screw fastening control program) according to the present embodiment is started (START), a bolt B is detected by the visual sensor 3 in step ST21. Specifically, from an image including a workpiece W and the bolt B captured by the visual sensor 3, the bolt B for performing a screw fastening work is detected, and the process proceeds to step ST22.

In step ST22, it is determined whether the detected bolt B is any one of types of registered bolts, that is, it is determined whether the detected bolt B is included in the types of the bolts registered by the pre-teaching program described with reference to FIG. 9 and FIG. 10. Further, in step ST22, when the detected bolt B is not the type of the registered bolt (NO), in other words, the detected bolt B is a new type of a bolt, the process proceeds to step ST27.

In step ST27, an alarm of “unregistered bolt type” is generated, and a worker performs a predetermined process based on the alarm, for example, a process after the determination of (NO), that is not included in the types of the bolts registered in step ST16 of FIG. 10 as described above.

On the other hand, in step ST22, when it is determined that the detected bolt B is one of the types of the registered bolts (YES), the process proceeds to step ST23, parameters of a screw fastening are automatically set, and thereby a socket is automatically selected. In other words, the parameters corresponding to the bolt B performing the screw fastening work may be set, and the socket SB may be changed to the socket SB corresponding to the bolt B performing the screw fastening work.

Further, the process proceeds to step ST24 and wherein the robot is moved to a vision correction position, and the screw fastening work of the bolt may be performed by a force control. For example, a center position of a head portion of the bolt B performing the screw fastening work is calculated from an image captured by the visual sensor 3, an end portion of the socket SB of the nut runner 5 is moved to the center position of the head portion of the bolt B performing a screw fastening work, and the screw fastening work is performed by the set parameters. In this case, the vision correction position in step ST24 corresponds to the center position of the head of the bolt B that performs the screw fastening work obtained from the image captured by the visual sensor 3.

Furthermore, in step ST25, it is determined whether or not an abnormality occurs, and when it is determined that the abnormality does not occur (NO), the screw fastening work of the bolt B is ended (END), and when it is determined that the abnormality occurs (YES), the process proceeds to step ST26 to diagnose an occurrence of the abnormality. Specifically, in step ST26, a problem caused by the occurrence of the abnormality may be identified by an execution history, and the parameters may be adjusted so as not to generate the problem or more.

As described above, according to the robot control program (pre-teaching program and screw fastening control program) according to the present embodiment, a screw fastening work may be efficiently performed, and diagnosis at the time of abnormality occurrence may be easily performed. It should be noted, for example, the robot control program described above is executed by the control unit 24 of the robot controller 2, but it is also possible to execute the robot control program by a computer and the like added to the outside when the arithmetic processing capability is insufficient.

The robot control program according to the present embodiment described above may be recorded in a computer-readable non-temporary recording medium or non-volatile semiconductor storage device and provided, or may be provided via wired or wireless communication. In this case, as a computer-readable non-temporary recording medium, for example, an optical disk such as a CD-ROM (Compact Disc Read Only Memory) or a DVD-ROM, or a hard disk device and the like may be considered. Further, a PROM (Programmable Read Only Memory), a Flash Memory (registered trademark) and the like are conceivable as nonvolatile semiconductor memory devices. In addition, the distribution from the server device may be provided via a wired or wireless WAN (Wide Area Network), LAN (Local Area Network), or via the Internet.

As described in detail above, according to the robot controller, the robot system, and the robot control program of the present embodiment, it is possible to efficiently and high accurately perform a fastening work by a fastener.

Although the embodiments of the present disclosure have been described in detail, the present disclosure is not limited to the individual embodiments described above. These embodiments include various additions and replacements without departing from the gist of the disclosure, or without departing from the idea and spirit of the disclosure derived from the content described in the claims and equivalents thereof, modification, partial deletion and the like are possible. For example, in the above-described embodiments, the order of each operation and the order of each process are shown as an example, and are not limited to these. The same applies when numerical values or equations are used in the description of the above-described embodiments.

Regarding the above-described embodiments and variations, the following description is further disclosed.

### Appendix 1

A robot controller (2) for controlling a robot (1) and causing the robot (1) to perform a fastening work using a fastener (B), comprising:
a storage unit (21) configured to store information of the fastener (B) and parameters (FB, FN) of performing the fastening work in association with the information of the fastener (B);
an acquisition unit (22) configured to acquire information (VB) of the fastener (B) performing the fastening work based on an output of a fastener recognition sensor (3);
a setting unit (23) configured to acquire and set the parameters (FB, FN) associated with the information of the fastener (B) from the storage unit (21) based on the acquired information of the fastener (B); and
a control unit (24) configured to control the robot (1) based on the set parameters (FB, FN).

### Appendix 2

The robot controller according to appendix 1, wherein
the control unit (24) is configured to control the robot (1) based on an output of a force sensor (4), which detects a parameter (FB) of a force control applied to the fastener (B) when performing the fastening work, and the set parameters (FB, FN).

### Appendix 3

The robot controller according to appendix 1 or 2, wherein
the information of the fastener (B) includes model information (VB1, VB2, VB3, . . . ) of each fastener (B1, B2, B3, . . . ).

### Appendix 4

The robot controller according to any one of appendixes 1 to 3, wherein
the information of the fastener (4) includes position information of each fastener (B1, B2, B3, . . . ) in a work target (W).

### Appendix 5

The robot controller according to any one of appendixes 1 to 4, wherein
the fastener recognition sensor (3) is a visual sensor configured to capture an image including the fastener (B) and a work target (W).

### Appendix 6

The robot controller according to any one of appendixes 1 to 5, wherein
the robot (1) includes a replaceable socket (SB),
the storage unit (21) is configured to store the information of the fastener (B), and information of the socket (SB) used when performing the fastening work in association with the information of the fastener (B),
the setting unit (23) is configured to acquire and set the information of the socket (SB) associated with the information of the fastener (B) from the storage unit (21) based on the acquired information of the fastener (B); and
the control unit (24) is configured to control to change the socket (SB) to be used when performing the fastening work based on the set information of the socket (SB).

### Appendix 7

The robot controller according to any one of appendixes 1 to 6, wherein
the robot (1) includes an external device (5) or an additional shaft configured to perform the fastening work using the fastener (B),
the control unit (24) is configured to control a force control parameter (FB) of the robot and parameters (NB, FB) of the external device (5) or the additional shaft based on the parameters (FB, FN) set by the setting unit (23).

### Appendix 8

The robot controller according to appendix 7, wherein
the external device (5) is a nut runner.

### Appendix 9

The robot controller according to any one of appendixes 1 to 8, wherein
the fastener (B) is a bolt,
the fastening work using the fastener (B) is a screw fastening work of the bolt (B).

### Appendix 10

The robot controller according to any one of appendixes 1 to 9, further comprising:
a warning output unit (7, 2, 6) configured to output warning information when an abnormality is occurred in the fastening work, wherein
the control unit (24) is configured to identify an cause of outputting the warning information and take an action to the warning information based on the information of the fastener (B) that performs the fastening work acquired by the acquisition unit (22), the output of the force sensor (4), and the parameters (FB, FN) set by the setting unit (23), after when the warning output unit (7, 2, 6) has output the warning information.

### Appendix 11

A robot system (100, 100′) comprising:
the robot controller (2) according to any one of appendixes 1 to 10;
the robot (1);
the fastener recognition sensor; and
the force sensor (4).

### Appendix 12

The robot system according to appendix 11, further comprising:
a display device (7) configured to display information of the fastener (B) acquired by the acquisition unit (22), an output of the force sensor (4), and the parameters (FB, FN) set by the setting unit (23).

### Appendix 13

The robot system according to appendix 12, wherein
the display device (7) is provided on the robot controller (2) or an operation panel (6) configured to teach various operations on the robot (1).

### Appendix 14

The robot system according to appendix 12, wherein
the display device (7) is connected to the robot controller (2) via a communication line. and is provided at a location separated from the robot (1).

### Appendix 15

A robot control program for controlling a robot (1) and causing the robot (1) to perform a fastening work using a fastener (B), the robot control program causing the arithmetic processing unit (24) to execute:
teaching information of the fastener (B) and parameters (FB, FN) of performing the fastening work in association with the information of the fastener (B);
registering the fastener (B) and the information of the fastener (B) and the parameters (FB, FN) of performing the fastening work in association with each type thereof;
detecting the fastener (B) that performs the fastening work by a fastener recognition sensor; and determining whether or not the fastener (B) that performs the fastening work is a type of the registered fastener.

### Appendix 16

The robot control program according to appendix 15, the robot control program causing the arithmetic processing unit (24) to further execute:
adjusting the parameters (FB, FN) associated with the information of the fastener (B).

### Appendix 17

A robot control program for controlling a robot (1) and causing the robot (1) to perform a fastening work using a fastener (B), the robot control program causing the arithmetic processing unit (24) to execute:
storing information of the fastener and parameters (FB, FN) of performing the fastening work in association with the information of the fastener (B) to a storage unit (21);
acquiring the information of the fastener (B) performing the fastening work based on an output of a fastener recognition sensor;
acquiring and setting the parameters (FB, FN) associated with the information of the fastener (B) from the storage unit (21) based on the acquired information of the fastener (B); and
controlling the robot (1) based on the set parameters (FB, FN).

### REFERENCE SIGNS LIST

1 Robot
2 Robot Controller
3 Visual Sensor (Fastener Recognition Sensor)
4 Force Sensor
5 Nut Runner (Screw Fastening Device)
6 Operation Panel
7 Display Device
8 Conveyor
10 Arm
21 Storage Unit
22 Acquisition Unit
23 Setting Unit
24 Control Unit
30 Visual Data Processing Device
31 Storage Unit
32 Visual Data Processing Unit
40 Force Data Processing Device
41 Storage Unit
42 Force Data Processing Unit
43 Automatic Adjustment Unit
100, 100′ Robot System
B, B1, B2, B3, . . . Bolt (Fastener)
FB, FB1, FB2, FB3, . . . Parameter (Parameter of Force Control)
NB, NB1, NB2, NB3, . . . Parameter (Parameter of Nut Runner)
SB, SB1, SB2, SB3, . . . Socket
VB, VB1, VB2, VB3, . . . Detection Model (Information of Fastener)
W Workpiece (Work Target)

1. A robot controller for controlling a robot and causing the robot to perform a fastening work using a fastener, comprising:
a storage unit configured to store information of the fastener and parameters of performing the fastening work in association with the information of the fastener;
an acquisition unit configured to acquire information of the fastener performing the fastening work based on an output of a fastener recognition sensor;
a setting unit configured to acquire and set the parameters associated with the information of the fastener from the storage unit based on the acquired information of the fastener; and
a control unit configured to control the robot based on the set parameters.

2. The robot controller according to claim 1, wherein
the control unit is configured to control the robot based on an output of a force sensor, which detects a parameter of a force control applied to the fastener when performing the fastening work, and the set parameters.

3. The robot controller according to claim 1, wherein
the information of the fastener includes model information of each fastener.

4. The robot controller according to claim 1, wherein
the information of the fastener includes position information of each fastener in a work target.

5. The robot controller according to claim 1, wherein
the fastener recognition sensor is a visual sensor configured to capture an image including the fastener and a work target.

6. The robot controller according to claim 1, wherein
the robot includes a replaceable socket,
the storage unit is configured to store the information of the fastener, and information of the socket used when performing the fastening work in association with the information of the fastener,
the setting unit is configured to acquire and set the information of the socket associated with the information of the fastener from the storage unit based on the acquired information of the fastener; and
the control unit is configured to control to change the socket to be used when performing the fastening work based on the set information of the socket.

7. The robot controller according to claim 1, wherein
the robot includes an external device or an additional shaft configured to perform the fastening work using the fastener,
the control unit is configured to control a force control parameter of the robot and parameters of the external device or the additional shaft based on the parameters set by the setting unit.

8. The robot controller according to claim 7, wherein
the external device is a nut runner.

9. The robot controller according to claim 1, wherein
the fastener is a bolt,
the fastening work using the fastener is a screw fastening work of the bolt.

10. The robot controller according to claim 1, further comprising:
a warning output unit configured to output warning information when an abnormality is occurred in the fastening work, wherein
the control unit is configured to identify an cause of outputting the warning information and take an action to the warning information based on the information of the fastener that performs the fastening work acquired by the acquisition unit, the output of the force sensor, and the parameters set by the setting unit, after when the warning output unit has output the warning information.

11. A robot system comprising:
the robot controller according to claim 1;
the robot;
the fastener recognition sensor; and
the force sensor.

12. The robot system according to claim 11, further comprising:
a display device configured to display information of the fastener acquired by the acquisition unit, an output of the force sensor, and the parameters set by the setting unit.

13. The robot system according to claim 12, wherein
the display device is provided on the robot controller or an operation panel configured to teach various operations on the robot.

14. The robot system according to claim 12, wherein
the display device is connected to the robot controller via a communication line. and is provided at a location separated from the robot.

15. A computer readable non-transitory tangible medium for storing a robot control program for controlling a robot and causing the robot (1) to perform a fastening work using a fastener, the robot control program causing the arithmetic processing unit to execute:
teaching information of the fastener and parameters of performing the fastening work in association with the information of the fastener;
registering the fastener and the information of the fastener and the parameters of performing the fastening work in association with each type thereof;
detecting the fastener that performs the fastening work by a fastener recognition sensor; and determining whether or not the fastener that performs the fastening work is a type of the registered fastener.

16. The computer readable non-transitory tangible medium for storing the robot control program according to claim 15, the robot control program causing the arithmetic processing unit to further execute:
adjusting the parameters associated with the information of the fastener.

17. A computer readable non-transitory tangible medium for storing a robot control program for controlling a robot and causing the robot to perform a fastening work using a fastener, the robot control program causing the arithmetic processing unit to execute:
storing information of the fastener and parameters of performing the fastening work in association with the information of the fastener to a storage unit;
acquiring the information of the fastener performing the fastening work based on an output of a fastener recognition sensor;
acquiring and setting the parameters associated with the information of the fastener from the storage unit based on the acquired information of the fastener; and
controlling the robot based on the set parameters.
